(19) United States
(12) Patent Application Publication
(10) Pub. No.: US 2008/0271370 A1
(43) Pub. Date: Nov. 6, 2008

(54) Planter

(75) Inventor: Morris Moskowitz, Monsey, NJ (US)

Correspondence Address: HEDMAN & COSTIGAN P.C., 1185 AVENUE OF THE AMERICAS, NEW YORK, NY, 10036, US

(73) Assignee: Missry Associates Inc., Dunellen, NJ (US)

(21) Appl. No.: 11/800,033

(22) Filed: May 3, 2007

(51) Int. Cl. A01G 9/02

(52) U.S. Cl. 47/66.1

(57) ABSTRACT

A planter having (a) a base element sized to accommodate a plant, said base having one or more side elements that form a wall of said base, said base having a upper portion and a lower portion, said upper portion having a first base mating edge and an integrally formed flange that extends horizontally and upwardly from said upper portion of the base to form a second base mating edge; and (b) a circumferential rim forming element having a first rim mating edge that is sized to engage the first base mating edge of said upper portion of said base element and having a second rim mating edge that is sized to engage said second base mating edge.

### BACKGROUND OF THE INVENTION

The present invention comprises a molded planter assembly having a novel structure and a novel method of manufacturing a molded planter assembly. In the prior art molded planters having separately manufactured rims are well known. U.S. Pat. No. 6,360,484 (the '484 patent) discloses a method of making a planter which is manufactured in two pieces. These types of molded planters are intended to imitate the frustoconical shape of traditional terracotta, marble or concrete planters that have a decorative rim around the upper edge of the base of the planter. The rim is formed from a molded in flange that cooperates with a circumferentially arranged collar that is sized to frictionally engage the side wall of the planter and includes a raised edge that engages a fitting in the side of the flange. The frictional engagement of the collar on the outward taper of the frustoconical side wall of the base of the planter necessitates that the planter be assembled by raising the collar from the bottom of the planter upwardly to the top.

EP 1 110 870 describes a flower pot having a circumferential rim that is inserted horizontally into a groove that is disposed circumferentially around the upper edge of a planter.

U.S. Pat. No. 6,605,440 provides a planter where the decorative rim is formed by placing one molded flower pot assembly into a separate molded flower pot assembly.

The applicant has devised an improved flower pot assembly that is based on a molded edge on the topmost part of a circular planter that extends horizontally and ends in an upwardly disposed edge that has means to engage a separate circumferential rim element that is sized to engage the outer part of the upwardly disposed edge and an inner portion of the topmost part of the circular planter. This design allows the planter to be assembled from the top side as the circumferential rim element is not friction fitted to the side wall of the planter. This design may also be applied to cylindrical, square, hexagonal etc. planters as the allows the circumferential rim forming element does not contact the side of a frustoconical planter as disclosed in the '484 patent.

### SUMMARY OF THE INVENTION

The invention provides a novel planter which is provided with (a) a base element sized to accommodate a plant, said base having one or more side elements that form a wall of said base, said base having a upper portion and a lower portion, said upper portion having a first base mating edge and an integrally formed flange that extends horizontally and upwardly from said upper portion of the base to form a second base mating edge; and (b) a circumferential rim forming element having a first rim mating edge that is sized to engage the first base mating edge of said upper portion of said base element and having a second rim mating edge that is sized to engage said second base mating edge.

The invention also provides a method of making a planter having a collar disposed about the upper portion of said planter, said method comprising:

(a) forming a base having side elements that form a wall of said base, said base having a upper portion and a lower portion, said upper portion having a first base mating edge and an integrally formed flange that extends horizontally and upwardly that extends from said upper portion of the base and ends with a second base mating edge;

(b) forming a circumferential rim forming element having a first rim mating edge that is sized to engage the first base mating edge of said upper portion of said base element and having a second rim mating edge that is sized to engage said second base mating edge; and

(c) attaching said first and second base mating edges to said first and said second rim mating edges.

Accordingly, it is a primary object of the invention to provide a novel molded planter having a collar which is partially formed with a rim forming element.

It is also an object of this invention to provide a method of making a molded planter having a collar by using a rim forming element.

It is also an object of this invention to provide a novel method of making a molded planter having a collar which may be used to manufacture planters having tapered or untapered flat sides as well as cylindrical planters or frustoconical planters. The side elements may be varied as desired and may be fitted to an appropriate collar which may be may to accommodate circular or non-circular planter bases.

These and other objects of the invention will become apparent from the appended specification.

### BRIEF DESCRIPTION OF THE SEVERAL VIEWS OF THE DRAWINGS

FIG. 1 is a partial cutaway [perspective of a planter according to the invention which shows the integral flange and the detached circumferential rim.

FIG. 2 is a cross-sectional view of an edge of a planter according to the invention.

FIG. 3 is a cross-sectional view of an edge of a planter according to the invention.

FIG. 4 is a cross-sectional view of an edge of a planter according to the invention.

FIG. 5 is a cross-sectional view of an edge of a planter according to the invention.

FIG. 6 is a cross-sectional view of an edge of a planter according to the invention.

FIG. 7 is a cross-sectional—perspective view of an edge of a planter according to the invention which shows the joint between the rim and the upper part of the planter and a portion of the interior of the space enclosed by the rim when it is in position at the top of the planter.

### DETAILED DESCRIPTION OF THE INVENTION

The novel molded planter according to the invention is preferably made in two parts: a base and a circumferential rim which is attached to the top portion of the base. The base may be cylindrical in shape, frustoconical, square, hexagonal or it may have a rounded shape of varying profiles. The profiles may be generated by constant variation of the radius of the planter as measured from the vertical axis of the planter.

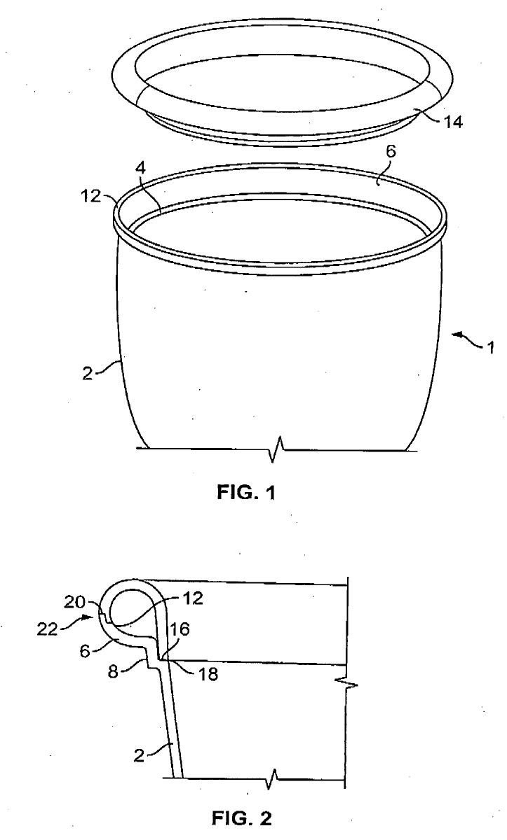

As shown in FIG. 1, the planter 1 of the invention has a base element 2 which has a rounded profile. The planter 1 has a first base mating edge 4 and an integrally formed flange 6 that extends horizontally and upwardly from said upper portion 8 of the base element 2 to form a second base mating edge 12. As best seen in FIG. 2, the circumferential rim forming element 14 has first circumferential rim mating edge 16 that is sized to engage the first base mating edge 18 of said upper portion 8 of said base element 2. The circumferential rim forming element 14 also has a second circumferential rim mating edge 20 that is sized to engage said second base mating edge 12. The joint 22 in FIG. 2 is a stepped profile which is analogous to a half-lap joint. The lap-joint may be held in place by sizing the circumferential rim forming element 14 so that a gentle pressure is placed against second base mating edge 12 when the planter base and circumferential rim forming element 14 are assembled. In the alternative, an adhesive may optionally be applied to the joint 22 to make the joinder of the circumferential rim and the upper portion 8 of the base element 2 permanent.

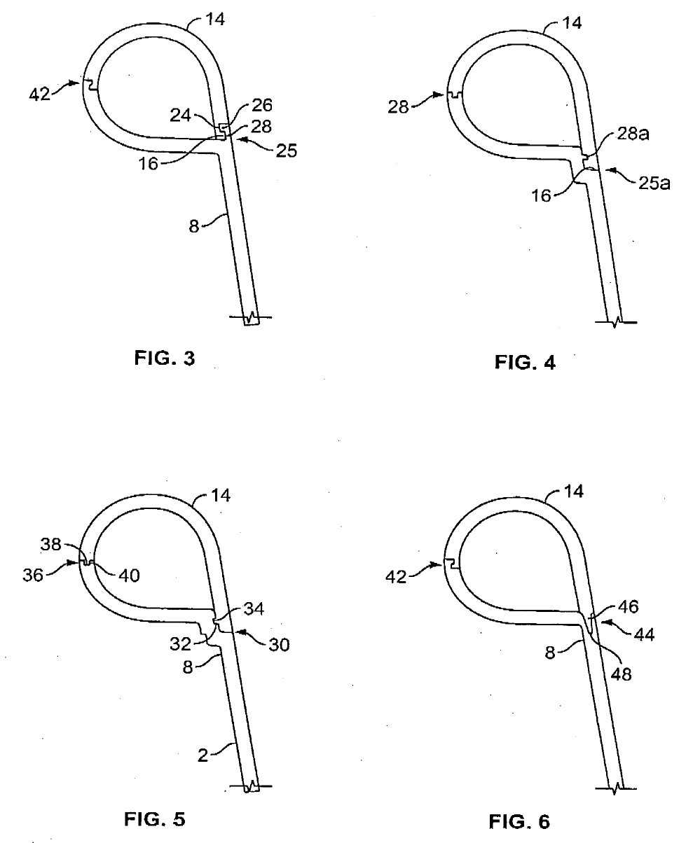

FIG. 3 discloses an alternate embodiment of a joint 25 between circumferential rim forming element 14 and the upper portion 8 of the base element where the joint 25 has a projection 16 which is seated in a groove 28 in rim forming element 14. At the upper end of upper portion 8 of the base element 2 is a groove 26 which engages a projection 24 in rim forming element 14 to form joint 12.

FIG. 4 discloses an alternate embodiment of a joint 25a between circumferential rim forming element 14 and the upper portion 8 of the base element where the joint 25a has a projection 28a seated in a groove 16a. The joint 12 in FIG. 3 is identical to the joint in FIG. 4 is identical in structure to joint 25.

As shown in FIG. 5, the circumferential rim forming element 14 and the upper portion 8 of the base element 2 are joined at joint 30 where a groove 32 is provided in the circumferential rim 14 and end 34 of circumferential rim 14 is cut back to engage a groove 36 on upper portion 8 of the base element. Rim projection 38 is sized to engage groove 32 on circumferential rim 14. Joint 40 is a joint having the same structure as joint 30.

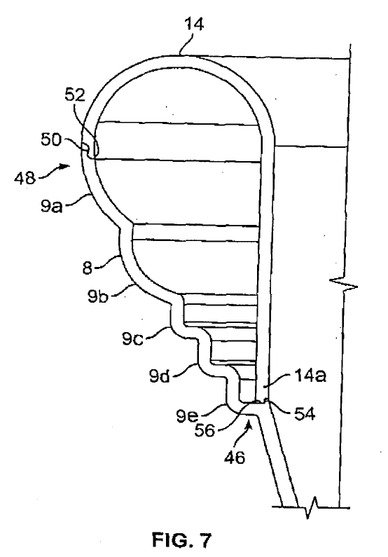

FIG. 6 is a further embodiment of the invention where joint 42 is formed in a identical manner to joint 40 of FIG. 5 but joint 44 is formed with an extended and tapered tongue 46 that is fitted into corresponding groove 48. FIG. 7 shows a circumferential rim forming element 14 and a ridged upper portion 8 of the planter base element 8. The cross-section of five different concentric ridges 9a, 9b, 9c, 9d, and 9e are shown in FIG. 7 but any combination or number of ridges or profile forming elements may be used to provide any selected esthetic effect. Joint 48 is formed between the circumferential rim forming element 14 connection with the upper edge portion of the planter rim by means of complimentary grooves 50 and 52. In a similar manner, complimentary grooves 54 and 56 provide a connection means at the lower end 14a of the circumferential rim forming element.

The planters are preferably made of injection molding resins which are selected by those who are skilled in the art to provide sufficient flexibility in the molded products. The desired degree of flexibility is such that the molded parts are preferably made by selecting the dimensions such that the parts may be assembled using snap-fit techniques In the alternative, it is possible to assemble the parts using adhesives, thermoforming techniques or ultra-sonic welding as desired. Planters may be made using the present invention which have the dimensions of planters that are conventionally marketed in garden supply centers or other retail outlets.

The invention has been illustrated by certain preferred embodiments but the invention is not limited to the preferred embodiments and may be varied within the scope of the present specification.

1. A planter which comprises (a) a base element sized to accommodate a plant, said base having one or more side elements that form a wall of said base, said base having a upper portion and a lower portion, said upper portion having a first base mating edge and an integrally formed flange that extends horizontally and upwardly from said upper portion of the base to form a second base mating edge; and (b) a circumferential rim forming element having a first rim mating edge that is sized to engage the first base mating edge of said upper portion of said base element and having a second rim mating edge that is sized to engage said second base mating edge.

2. A planter as defined in claim 1 wherein the first mating edge of the base element has a first base mating edge that has a groove that is sized to engage a corresponding ridge on said first rim mating element.

3. A planter as defined in claim 1 wherein the first mating edge of the base element has a first base mating edge that has a recessed groove that is sized to engage a corresponding recessed groove on said first rim mating element.

4. A planter as defined in claim 1 wherein the first mating edge of the base element has a second base mating edge that has a groove that is sized to engage a corresponding ridge on said second rim mating element.

5. A planter as defined in claim 1 wherein the first mating edge of the base element has a second base mating edge that has a recessed groove that is sized to engage a corresponding recessed groove on said second rim mating element.

6. A planter which comprises (a) a frustoconically shaped base element sized to accommodate a plant, said base having one or more side elements that form a wall of said base, said base having a upper portion and a lower portion, said upper portion having a first base mating edge and an integrally formed flange that extends horizontally and upwardly in a curve that extends from said upper portion of the base and ends with a second base mating edge; and (b) a circumferential rim forming curved element having a first rim mating edge that is sized to engage the first base mating edge of said upper portion of said base element and having a second rim mating edge that is sized to engage said second base mating edge.

7. A planter as defined in claim 6 wherein the first mating edge of the base element has a first base mating edge that has a groove that is sized to engage a corresponding ridge on said first rim mating element.

8. A planter as defined in claim 6 wherein the first mating edge of the base element has a first base mating edge that has a recessed groove that is sized to engage a corresponding recessed groove on said first rim mating element.

9. A planter as defined in claim 6 wherein the first mating edge of the base element has a second base mating edge that has a groove that is sized to engage a corresponding ridge on said second rim mating element.

10. A planter as defined in claim 6 wherein the first mating edge of the base element has a second base mating edge that has a recessed groove that is sized to engage a corresponding recessed groove on said second rim mating element.

11. A method of forming a planter having a collar disposed about the upper portion of said planter, said method comprising:
(a) forming a base having side elements that form a wall of said base, said base having a upper portion and a lower portion, said upper portion having a first base mating edge and an integrally formed flange that extends horizontally and upwardly that extends from said upper portion of the base and ends with a second base mating edge;
(b) forming a circumferential rim forming element having a first rim mating edge that is sized to engage the first base mating edge of said upper portion of said base element and having a second rim mating edge that is sized to engage said second base mating edge; and
(c) attaching said first and second base mating edges to said first and said second rim mating edges.

12. A method as defined in claim 11 wherein the first mating edge of the base element has a first base mating edge that has a groove that is sized to engage a corresponding ridge on said first rim mating element.

13. A method as defined in claim 11 wherein the first mating edge of the base element has a first base mating edge that has a recessed groove that is sized to engage a corresponding recessed groove on said first rim mating element.

14. A planter as defined in claim 11 wherein the first mating edge of the base element has a second base mating edge that has a groove that is sized to engage a corresponding ridge on said second rim mating element.

15. A planter as defined in claim 11 wherein the first mating edge of the base element has a second base mating edge that has a recessed groove that is sized to engage a corresponding recessed groove on said second rim mating element.
